(19) United States
(12) Patent Application Publication
(10) Pub. No.: US 2013/0254326 A1
(43) Pub. Date: Sep. 26, 2013

(54) ELECTRONIC DEVICE, CLOUD STORAGE SYSTEM FOR MANAGING CLOUD STORAGE SPACES, METHOD AND TANGIBLE EMBODIED COMPUTER READABLE MEDIUM THEREOF

(71) Applicants: Yung-Chiuan Weng, Taipei City (TW); Chun-Hao Yeh, Hangzhou (CN); Wei Zhang, Hangzhou (CN); Bin Qian, Hangzhou (CN)

(72) Inventors: Yung-Chiuan Weng, Taipei City (TW); Chun-Hao Yeh, Hangzhou (CN); Wei Zhang, Hangzhou (CN); Bin Qian, Hangzhou (CN)

(73) Assignee: EGIS TECHNOLOGY INC., Taipei City (TW)

(21) Appl. No.: 13/533,525

(22) Filed: Jun. 26, 2012

(30) Foreign Application Priority Data
Mar. 23, 2012 (TW) 101110210

(51) Int. Cl. G06F 15/167

(52) U.S. Cl. 709/215; 709/216

(57) ABSTRACT

The present invention discloses an electronic device, a cloud storage system, a method thereof and a tangible embodied computer readable medium. The cloud storage system comprises at least one server and an electronic device. The at least one server provides a plurality of cloud storage spaces for accessing data. The electronic device comprises a storage management interface and is connected to each of the servers via Internet in order to access the cloud storage space. Wherein, the cloud storage spaces are integrated as a virtual storage space by the electronic device for a user to access data therefrom. The user can concurrently access the cloud storage spaces through the storage management interface of the electronic device, or access one of the cloud storage spaces by multi-thread or multi-process so as to raise the access speed.

### CROSS-REFERENCE TO RELATED APPLICATION

This application claims the benefit under 35 U.S.C. §119 of Taiwan Patent Application No. 101110210, filed Mar. 23, 2012, which is hereby incorporated by reference in its entirety.

### BACKGROUND

1. Field of the Invention

The present invention generally relates to a storage management system, in particular to a storage management system for managing the cloud storage spaces.

2. Description of the Related Art

With the development of technology, the Internet has become a necessity for the modern living. Surfing Internet, sending/receiving e-mails, playing on-line games and the like have become an important part of the modern living. Nowadays, as the cloud computing technology advances, people can enjoy various cloud computing services, and one of which is the cloud storage space. The cloud storage space is a free or chargeable network storage space provided by the providers of cloud files storage service, such as “sky drive” provided by Microsoft, “Dropbox”, various private clouds, hybrid clouds and the like.

However, there are many drawbacks existing in the conventional cloud storage space. Wherein, as being unstable, the conventional cloud storage space is apt to crash. Therefore, the files uploaded or downloaded by the user tend to get lost. Moreover, the conventional cloud storage space cannot restore the lost files for lack of the backup functions. Also, since the conventional cloud storage space depends on network connection, unstable network connection strongly influences the data access speed thereof.

In addition, the conventional cloud storage space can just provide a limited storage space for the user to store data. That is to say, the user must pay additional fees for more storage space, which is not economic. Furthermore, if the user wants to use multiple cloud storage spaces at the same time, the user has to respectively operate the operation interface of each of the cloud storage spaces, which is not convenient for the user. Most significantly, the conventional cloud storage space is subject to the question in security against the hacker invasion. Accordingly, the data stored in the cloud storage space by the user is vulnerable to the hacker invasion and the security thereof is not guaranteed.

Therefore, it is the primary object of the present invention to provide a cloud storage system which is able to provide additional storage space without significant increase of the cost, raise the data access speed, effectively restore the lost files, improve the security thereof and make the operation interface thereof more user friendly.

### BRIEF SUMMARY

Therefore, it is a primary objective of the present invention to provide an electronic device, a cloud storage system, a method thereof and a tangible embodied computer readable medium to resolve the problems in the conventional cloud storage system, such as limited storage space, unstable data access speed, failing to effectively restore the lost/damaged files, poor security and inconvenience.

To achieve the foregoing objective, the present invention provides a cloud storage system. The cloud storage system comprises at least one server for providing a plurality of cloud storage spaces for data access, and an electronic device comprising a storage management interface and connected to the at least one server via the network for accessing the cloud storage spaces. Wherein, the cloud storage spaces are integrated as a virtual storage space by the electronic device for the user to access data therefrom, the cloud storage spaces are concurrently accessed through the storage management interface, or accessed one at a time in multi-thread or multi-process manners, thereby improving an access speed thereof.

To achieve the foregoing objective, the present invention further provides an electronic device comprising a storage management interface and connected to a plurality of cloud storage spaces via the network. Wherein, the cloud storage spaces are integrated as a virtual storage space by the electronic device for the user to access data therefrom, the cloud storage spaces are concurrently accessed through the storage management interface, or accessed one at a time in multi-thread or multi-process manners, thereby improving an access speed thereof.

To achieve the foregoing objective, the present invention still further provides a cloud storage management method, comprising the following steps of: providing a plurality of cloud storage spaces for data access by at least one server; providing a storage management interface by an electronic device, and connecting the electronic device to the at least one server via the network for accessing the cloud storage spaces; and integrating the cloud storage spaces as a virtual storage space by the electronic device for the user to access data therefrom, the cloud storage spaces are concurrently accessed through the storage management interface, or accessed one at a time in multi-thread or multi-process manners, thereby improving an access speed thereof.

Wherein, the cloud storage spaces are integrated as a virtual storage space by the electronic device for the user to access data therefrom, the user concurrently accesses the cloud storage spaces through the storage management interface of the electronic device, or accesses one of the cloud storage spaces by multi-thread or multi-process so as to raise the access speed of the cloud storage system.

Preferably, a file attempted to be uploaded to the virtual storage may be divided into a plurality of file blocks, and the file blocks may be respectively transmitted to different cloud storage space and stored in different cloud storage spaces.

Preferably, a portion or all of the file blocks may be encrypted by the electronic device.

Preferably, the electronic device may determine the size of each of the file blocks according to the attribute of the file.

Preferably, the electronic device may determine that the file blocks are stored in the same cloud storage space or different cloud storage spaces according to the attribute of the file.

Preferably, the electronic device may back up the file blocks by way of the mirror backup, or the electronic device restores lost file blocks by the error-checking and/or correcting.

Preferably, mirrored data generated by the mirror backup or error-checking and/or correcting data generated by the error-checking and/or correcting may be uploaded along with the file blocks by the electronic device.

Preferably, sufficient number of the cloud storage spaces may be selected by the electronic device according to the connection speed between each of the cloud spaces and the electronic device to retrieve the file blocks so as to rebuild the file.

Preferably, the mirrored data generated by the mirror backup or the error-checking and/or correcting data generated by the error-checking and/or correcting may be stored in different cloud storage spaces by the electronic device.

To achieve the foregoing objective, the present invention still further provides a tangible embodied computer readable medium carrying a computer program adopted to cause a computer to perform a method comprises the following steps of: providing a storage management interface by the computer, and connecting the computer to at least one server providing cloud storage spaces via a network for accessing the cloud storage spaces; integrating the cloud storage spaces as a virtual storage space by the computer for a user to access data therefrom; and concurrently accessing the cloud storage spaces through the storage management interface of the computer, or accessing one of the cloud storage spaces by multi-thread or multi-process so as to raise an access speed of the computer.

To achieve the foregoing objective, the present invention still further provides a cloud storage system. The system comprises a server for providing a cloud storage space for data access and an electronic device comprising a storage management interface. The electronic device is connected to the at least one server via the network for accessing the cloud storage space. Wherein the cloud storage space is accessed in multi-thread or multi-process manners through the storage management interface of the electronic device by a user, thereby improving the access speed thereof.

To sum up, the electronic device, the cloud storage system for managing cloud storage spaces, the method and the tangible embodied computer readable medium thereof according to the present invention have one or more of the following advantages:

(1) The present invention integrates the cloud storage spaces as a virtual storage space, which can provide a bigger storage space without significantly increasing the cost.

(2) The present invention can concurrently access the cloud storage spaces or access one of the cloud storage spaces by multi-thread or multi-process, which can effectively raise the data access speed.

(3) The present invention can back up or restore the file by the mirror backup, the error-checking and/or correcting or any other data check method. Accordingly, the present invention can effectively rebuild the lost or damaged file.

(4) The present invention can not only divide the file into a plurality of file blocks before uploading the file, but also provide an encryption mechanism for the file blocks, which significantly tighten up the security of the cloud storage system.

(5) The present invention can integrate a plurality of cloud storage spaces as a virtual storage space for the user to manage, which can provide a more convenient interface for the user.

### BRIEF DESCRIPTION OF THE DRAWINGS

The detailed structure, operating principle and effects of the present invention will now be described in more details hereinafter with reference to the accompanying drawings that show various embodiments of the invention as follows.

FIGS. 1A-1C are respectively the first, second and third block diagrams of the cloud storage system for managing cloud storage spaces according to the present invention.

FIG. 2 is the block diagram of the first preferred embodiment of the cloud storage system for managing cloud storage spaces according to the present invention.

FIG. 3 is the flow chart of the first preferred embodiment of the cloud storage system for managing cloud storage spaces according to the present invention.

FIG. 4 is the schematic view of the second preferred embodiment of the cloud storage system for managing cloud storage spaces according to the present invention.

FIG. 5 is the flow chart of the third preferred embodiment of the cloud storage system for managing cloud storage spaces according to the present invention.

FIG. 6 is the flow chart of the cloud storage management method according to the present invention.

### DETAILED DESCRIPTION

The technical content of the present invention will become clear by the detailed description of the following embodiments and the illustration of related drawings as follows.

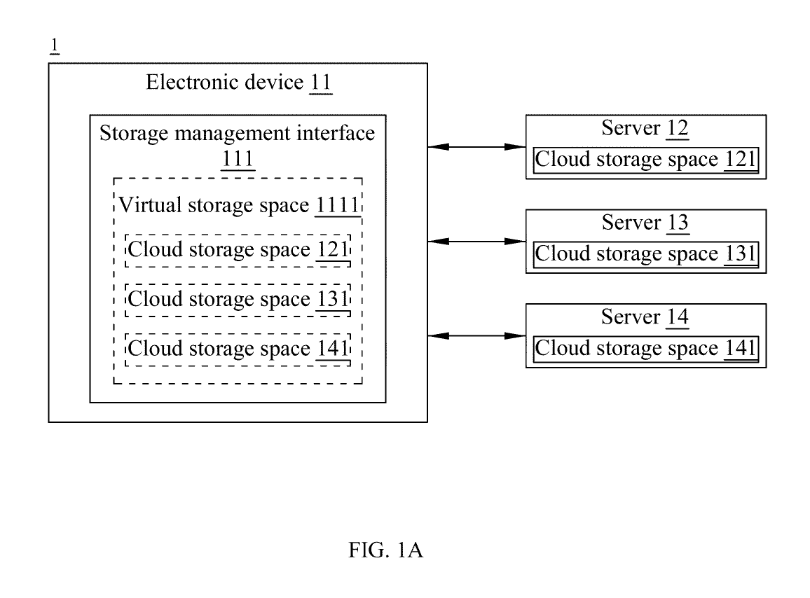

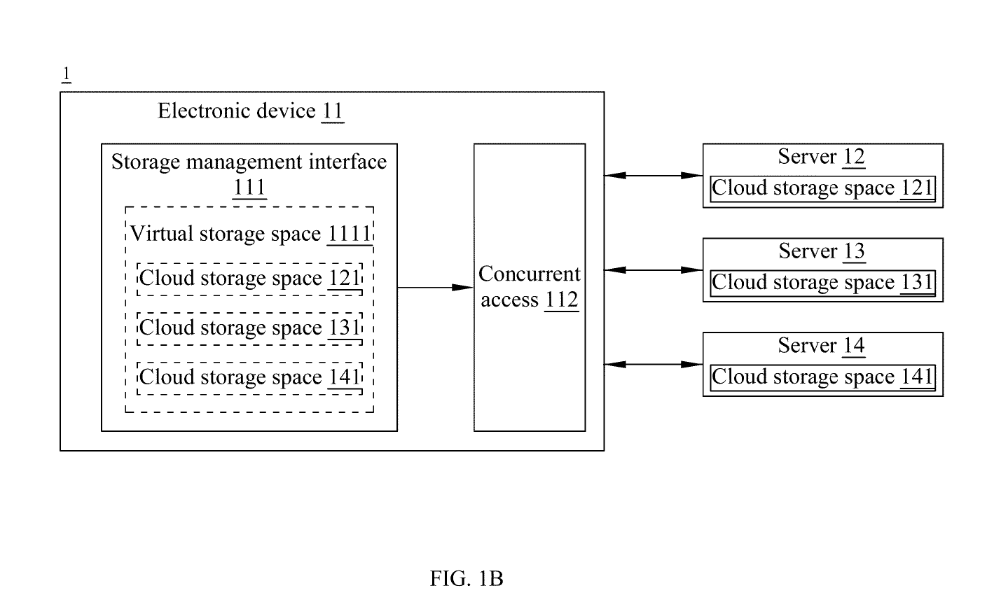

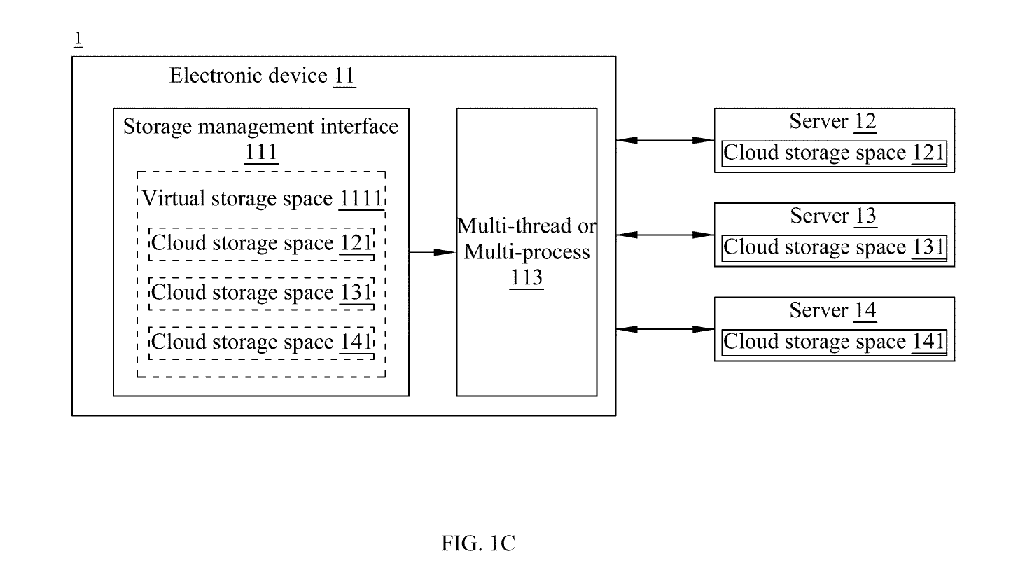

With reference to FIG. 1A for the first block diagram of the cloud storage system for managing cloud storage spaces in accordance with the present invention. As shown in FIG. 1, the cloud storage system 1 comprises the servers 12, 13, 14 and electronic device 11. The servers 12, 13, 14 respectively provide the cloud storage spaces 121, 131 and 141 for data access. The electronic device 11 comprises the storage management interface 111 and is connected to the servers 12, 13, 14 via the Internet for accessing the cloud storage spaces 121, 131 and 141. The cloud storage spaces 121, 131 and 141 may be public clouds, such as “sky drive” provided by Microsoft, “Dropbox” and the like, which can also be private clouds or hybrid clouds.

Wherein, the cloud storage spaces 121, 131 and 141 are integrated as a virtual storage space 111 by the electronic device 11 for the user to access data therefrom in order to provide the virtual storage space 1111 whose capacity is in the sum of the capacities of the cloud storage spaces 121, 131 and 141. In addition, the capacity of the virtual storage space 1111 can increase with the increase of the capacity of each of the cloud storage spaces 121, 131 and 141. Besides, the user can manage the cloud storage spaces 121, 131 and 141 via the storage management interface 111. Accordingly, the user can manage the cloud storage spaces 121, 131 and 141 via only one operation interface instead of respectively operating the operation interface of each of the cloud storage spaces 121, 131 and 141. When applied in practice, the electronic device 11 may be an intelligent mobile phone, a personal computer or the like, which can be connected to the servers providing cloud storage service via the network. On the other hand, the electronic device 11 may also be a server, which can be connected to the servers providing cloud storage service for providing the aforementioned service.

Moreover, the user concurrently accesses the cloud storage spaces 121, 131 and 141 through the storage management interface 111 of the electronic device 11, or accesses one of the cloud storage spaces 121, 131 and 141 by multi-thread or multi-process. In addition, the user can still access the cloud storage space by multi-thread or multi-process even if there is only one cloud storage space. Accordingly, the present invention can significantly enhance the data access speed and effectively improve the efficiency of use.

With reference to FIGS. 1B and 1C for the second and the third block diagrams of the cloud storage system for managing cloud storage spaces in accordance with the present invention. As shown in FIG. 1B, the user can access the cloud storage spaces 121, 131 and 141 by way of concurrent access 112 through the storage management interface 111 of the electronic device 11 to increase the data access speed. As shown in FIG. 1C, the user can also access one of the cloud storage spaces 121, 131 and 141 by way of multi-thread or multi-process 113 through the storage management interface 111 of the electronic device 11. Accordingly, the present invention can significantly raise the data access speed and effectively improve the efficiency of use.

Conventionally, as there is no an effective management system for managing the cloud storage spaces, the user needs to respectively operate the operation interface of each of the cloud storage spaces when using multiple cloud storage spaces at a time, which is not convenient for the user. However, the present invention provides an operation interface integrating multiple cloud storage spaces. Accordingly, user just needs to operate the operation interface of the virtual storage space whose capacity is in the sum of the capacities of the multiple cloud storage spaces to manage the multiple cloud storage spaces at a time. Besides, the present invention can further raise the data access speed by concurrently accessing to the cloud storage spaces or accessing one of the cloud storage spaces by multi-thread or multi-process. Therefore, the cloud storage system can provide a more humanized operation interface for the user to more effectively use multiple cloud storage spaces, which improves the conventional cloud storage system.

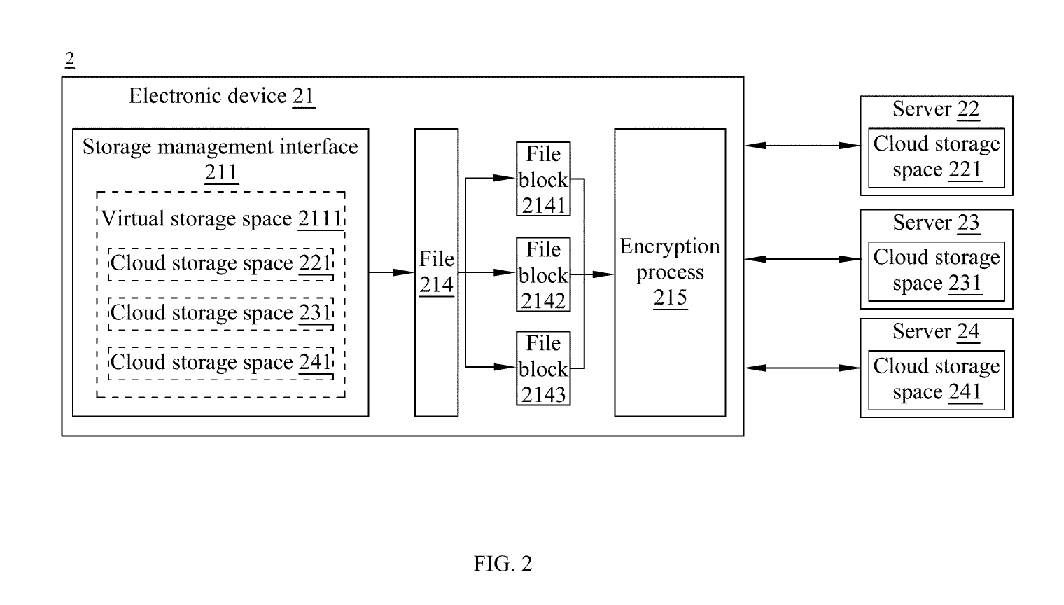

With reference to FIG. 2 for the block diagram of the first preferred embodiment of the cloud storage system for managing cloud storage spaces in accordance with the present invention. As shown in FIG. 2, the cloud storage system 2 comprises the servers 22, 23, 24 and electronic device 21. The servers 22, 23, 24 respectively provide the cloud storage spaces 221, 231 and 241 for data access. The electronic device 21 comprises the storage management interface 211 and is connected to the servers 22, 23, 24 via the Internet for accessing the cloud storage spaces 221, 231 and 241. Similarly, the cloud storage spaces 221, 231 and 241 are integrated as the virtual storage space 2111 by the electronic device 21 for the user to access data therefrom.

In the embodiment, via the electronic device 21, the user can divide the file 214 attempted to be uploaded to the virtual storage space 2111 into a plurality of file blocks 2141, 2142 and 2143, and then encrypt a portion or all of the file blocks 2141, 2142 and 2143 by encryption process 215 to transmit the file blocks 2141, 2142 and 2143 to different cloud storage spaces 221, 231 and 241 for storage.

Besides, the electronic device 21 can further determine the sizes of the file blocks 2141, 2142 and 2143 according to the attribute of the file 214. Furthermore, the electronic device 21 can further determine whether or not the file blocks 2141, 2142 and 2143 are stored in the same cloud storage space so as to improve the efficiency of the data access. For example, if the file attempted to be uploaded is a graphic file with small size, the electronic device 21 will upload the graphic file to the default cloud storage space; if the file attempted to be uploaded is a video file with big size, the electronic device 21 will divide the video file into a plurality of file blocks to respectively store the file blocks in different cloud storage spaces. With the aforementioned mechanism, the present invention can more effectively access the file, which improves the conventional cloud storage system indeed.

It is noteworthy to point out that single convention cloud storage system tends to be invaded by the hacker, such that the important data stored in the conventional cloud storage system by the user tends to be stolen by the hacker. However, the present invention can divide the file into a plurality of file blocks and then respectively store the file blocks in different cloud storage spaces. Accordingly, if the hacker wants to steal the data stored in one of the cloud storage spaces, the hacker can only obtain partial file blocks rather than the complete file. In addition, the present invention can further encrypt a portion or all of the file blocks, which can effectively prevent from the hacker invasion and tighten up the security of the cloud storage space. Moreover, the present invention can further upload the file according to the attribute thereof, which can better the efficiency of the data access.

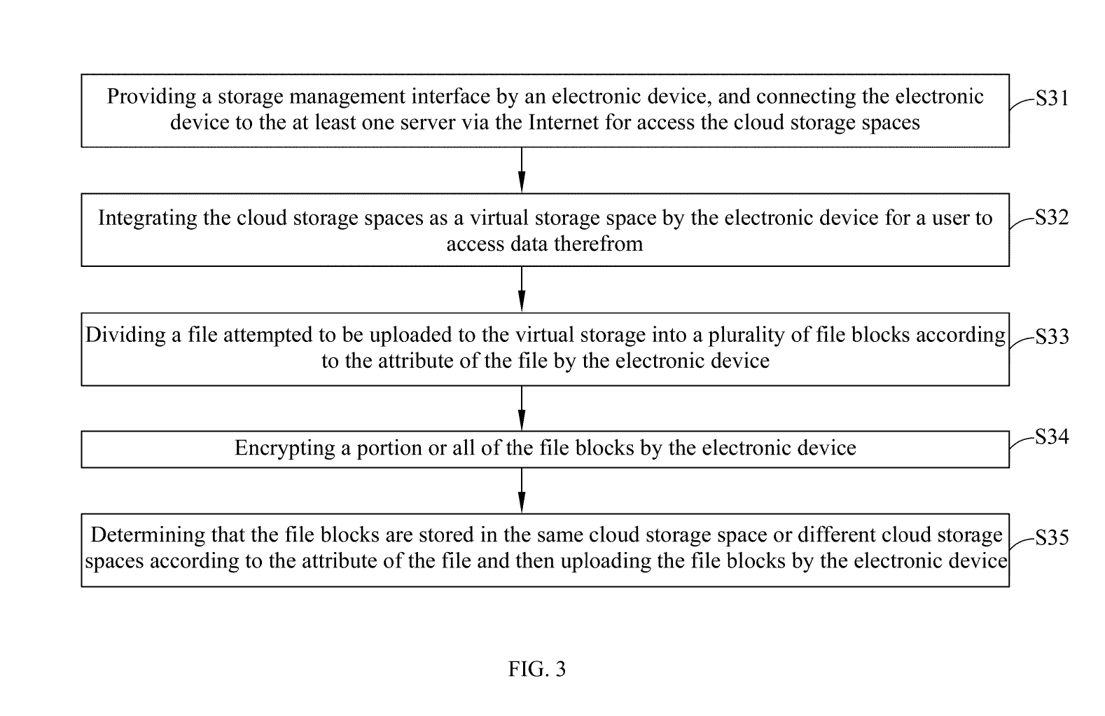

With reference to FIG. 3 for the flow chart of the first preferred embodiment of the cloud storage system for managing cloud storage spaces in accordance with the present invention. The embodiment comprises the following steps of:

In the step S31, providing a storage management interface by an electronic device, and connecting the electronic device to at least one server via the Internet for accessing the cloud storage spaces.

In the step S32, integrating the cloud storage spaces as a virtual storage space by the electronic device for a user to access data therefrom.

In the step S33, dividing a file attempted to be uploaded to the virtual storage space into a plurality of file blocks according to the attribute of the file by the electronic device.

In the step S34, encrypting a portion or all of the file blocks by the electronic device.

In the step S35, determining that the file blocks are stored in the same cloud storage space or different cloud storage spaces according to the attribute of the file and then uploading the file blocks by the electronic device.

In addition, a tangible embodied computer readable medium carrying a computer program may be adopted to cause a computer to perform the aforementioned method.

As described above, the cloud storage spaces in the present invention may be the public cloud, the private cloud, the hybrid cloud and the like. In the following embodiment, the public cloud is used for illustration, but the present invention is not limited to public cloud only.

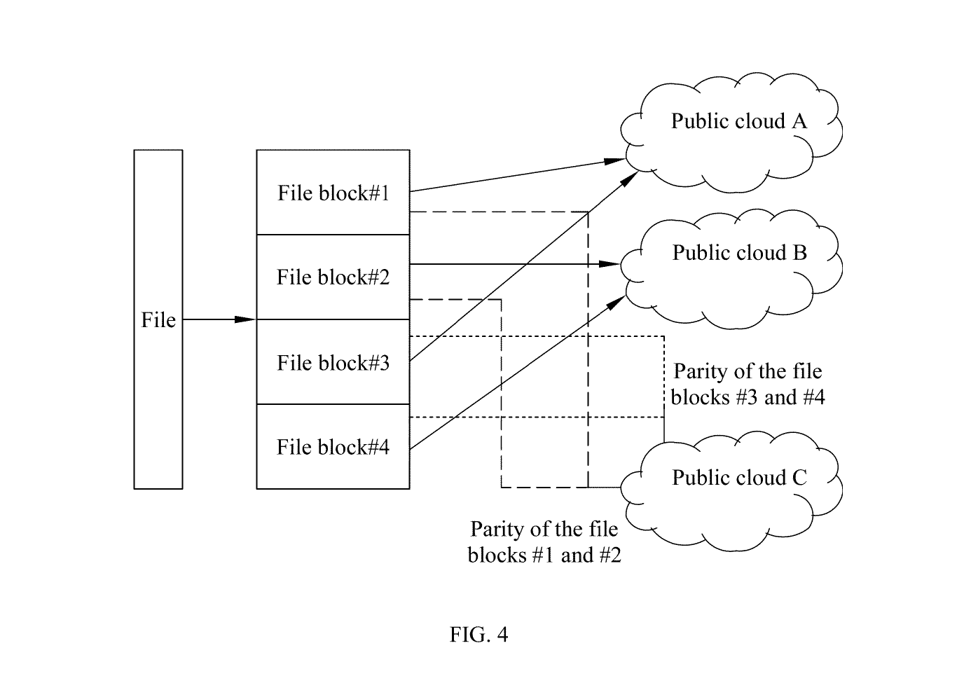

With reference to FIG. 4 for the schematic view of the second preferred embodiment of the cloud storage system for managing cloud storage spaces in accordance with the present invention. In addition to the aforementioned functions, the present invention further provides the mechanism for data backup by way of multiple data check methods. Accordingly, the important data stored in the cloud storage space by the user can be prevent from getting lost due to the crash on the server providing the public cloud or unstable network connection.

For example, the cloud storage system according to the present invention can back up or restore the files uploaded by the user by means of the mirror backup or the error-checking and/or correcting, such that the file can be rebuilt and retrieved even if certain of the public clouds cannot be accessed. Similarly, the user can further take the security of the file and the available capacity of the virtual storage space into consideration to determine which mechanism is adopted to back up the file. For example, if the file that the user wants to upload is a graphic file or a text file, the user can choose to use the mirror backup to back up the file because the size of the file is small; on the contrary, if the file that the user wants to upload is a video file, the user can choose to use the error-checking and/or correcting to restore the file because the size of the file is big. Wherein, the mirrored data generated by the mirror backup or the error-checking and/or correcting data generated by the error-checking and/or correcting may be uploaded along with the file blocks, or be dealt with off-line, which can increase the upload speed for the user. Also, the mirrored data or the error-checking and/or correcting data may be stored in different cloud storage spaces.

As shown in FIG. 4, the file attempted to be uploaded is divided into several file blocks #1, #2, #3 and #4. The file blocks #1 and $3 are stored in the public cloud A, and the file blocks #2 and #4 are stored in the public cloud B. The error-checking and/or correcting data of the file blocks #3 and #4 are stored in the public cloud C, just as the error-checking and/or correcting data of the file blocks #1 and #2. Also, the error-checking and/or correcting data of the file blocks #1, #2, #3 and #4 can be alternately stored in the public clouds A, B and C. Also, there are more ways to store the file blocks and the error-checking and/or correcting data. The aforementioned is just for example instead of limitation, and the present invention is not limited to such arrangement only.

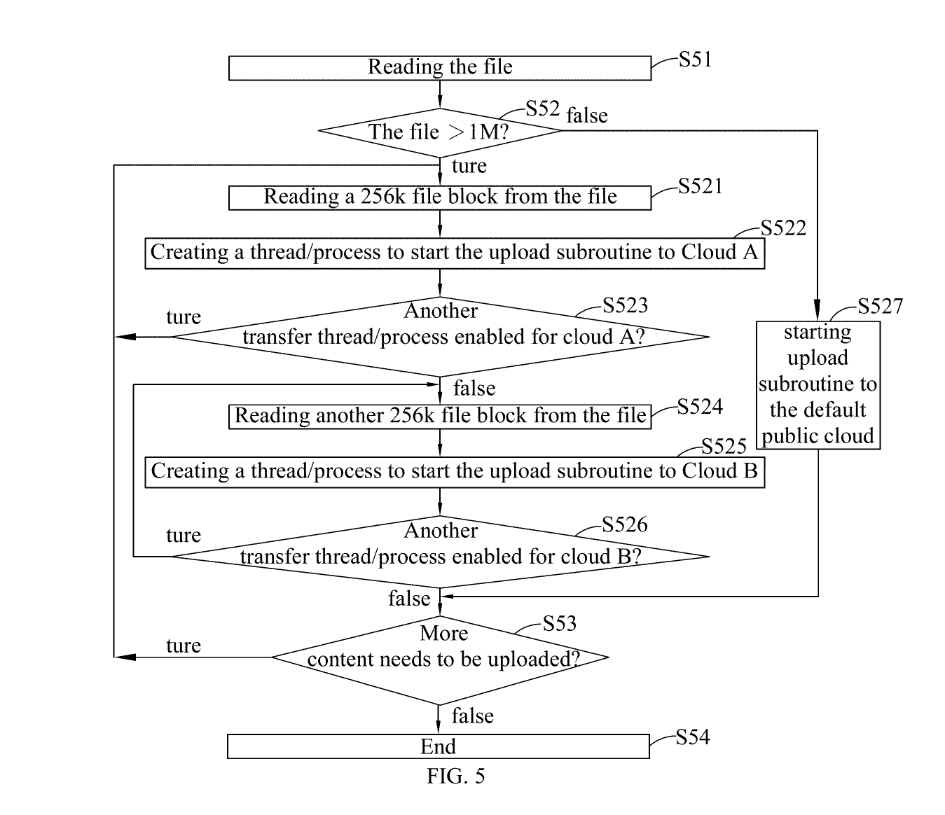

Please refer to FIGS. 4 and 5. FIG. 5 is the flow chart of the third preferred embodiment of the cloud storage system for managing cloud storage spaces in accordance with the present invention. The embodiment illustrates that the cloud storage system according to the present invention divides the file into a plurality of file blocks and uploads the file according to the attribute of the file. The embodiment comprises the following steps of:

In the step S51, reading the file attempted to be uploaded. Next step is the step S52. In the step S52, determining whether or not the size of the file attempted to be uploaded is larger than 1M? If it is, next step is the step S521; if it isn't, next step is the step S527.

In the step S521, reading a 256 k file block from the file attempted to be uploaded. Next step is the step S522.

In the step S522, creating a thread/process to start the upload subroutine to Cloud A. Next step is the step S523.

In the step S523, determining whether or not there is another transfer thread/process enabled for cloud A? If there is another transfer thread/process enabled for cloud A, next step is back to the step S521 and the aforementioned process is repeated; if there is no another transfer thread/process enabled for cloud A, next step is the step S524.

In the step S524, reading another 256 k file block from the file attempted to be uploaded. Next step is the step S525. In the step S525, creating a thread/process to start the upload subroutine to Cloud B.

Next step is the step S526.

In the step S526, determining whether or not there is another transfer thread/process enabled for cloud B? If there is another transfer thread/process enabled for cloud B, next step is back to the step S524 and the aforementioned process is repeated; if there is no another transfer thread/process enabled for cloud B, next step is the step S53.

In the step S527, starting upload subroutine to the default public cloud. Nest step is the step S53.

In the step S53, determining whether or not there is more content needing to be uploaded? If there is more content needing to be uploaded, next step is back to the step S521 and the aforementioned process is repeated; if there is no content needing to be uploaded, next step is the step S54.

In the step S54, ending the upload process. Although the above description about the cloud storage system for managing cloud storage spaces in accordance with the present invention has illustrated the concept of the cloud storage management method in accordance with the present invention, the following still provides the flow chart to specify the cloud storage management method in accordance with the present invention.

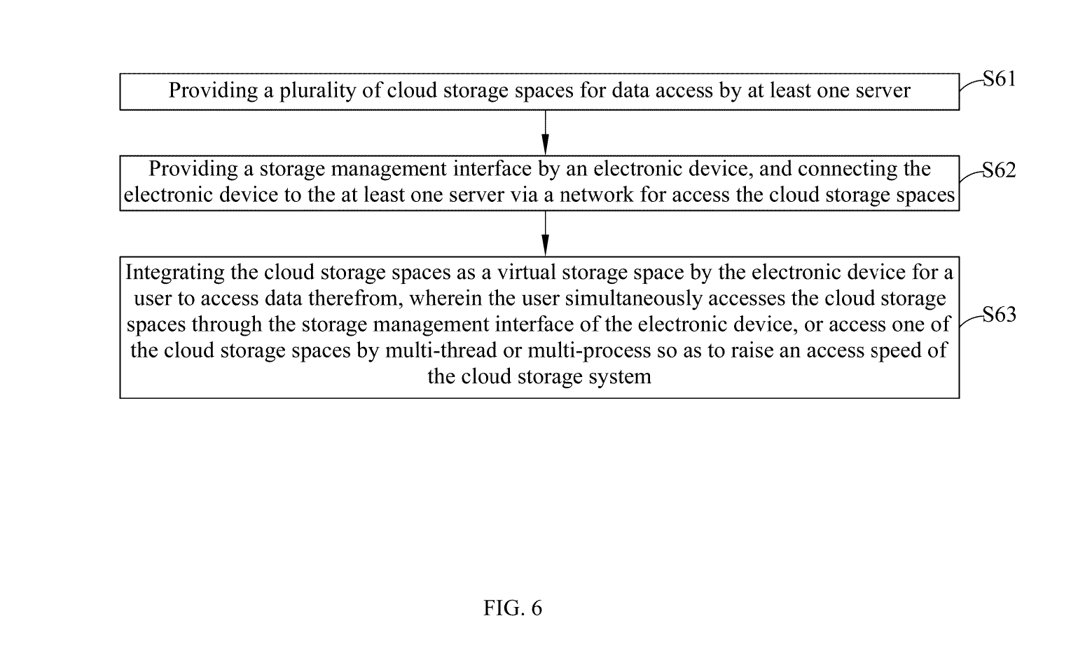

With reference to FIG. 6 for the flow chart of the cloud storage management method in accordance with the present invention. In the step S61, providing a plurality of cloud storage spaces for data access by at least one server.

In the step S62, providing a storage management interface by an electronic device, and connecting the electronic device to the at least one server via a network for accessing the cloud storage spaces.

In the step S63, integrating the cloud storage spaces as a virtual storage space by the electronic device for a user to access data therefrom, wherein the user concurrently accesses the cloud storage spaces through the storage management interface of the electronic device, or accesses one of the cloud storage spaces by multi-thread or multi-process so as to raise an access speed of the cloud storage system.

The detailed description and the exemplary embodiments of the cloud storage management method in accordance with the present invention have been described in the description of the cloud storage system for managing cloud storage spaces; therefore, they will not be repeated herein again.

In summation of the description above, the present invention integrates the cloud storage spaces as a virtual storage space, which can provide a bigger storage space without significantly increasing the cost. The present invention can concurrently access the cloud storage spaces or access one of the cloud storage spaces by multi-thread or multi-process, which can effectively raise the data access speed. The present invention can back up or restore the file by the mirror backup, the error-checking and/or correcting or any other data check method. Accordingly, the present invention can effectively rebuild the loss or damaged file. The present invention can not only divide the file into a plurality of file blocks before uploading the file, but also provide an encryption mechanism for the file blocks, which significantly tighten up the security of the cloud storage system. The present invention can integrate a plurality of cloud storage spaces as a virtual storage space for the user to manage, which can provide a more convenient interface for the user.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A cloud storage system, comprising:
at least one server, arranged for providing a plurality of cloud storage spaces for data access; and
an electronic device, comprising a storage management interface, the electronic device connected to the at least one server via a network for accessing the cloud storage spaces;
wherein, the cloud storage spaces are integrated as a virtual storage space by the electronic device for a user to access data therefrom, the cloud storage spaces are concurrently accessed through the storage management interface, or accessed one at a time in multi-thread or multi-process manners, thereby improving an access speed thereof.

2. The cloud storage system of claim 1, wherein a file attempted to be uploaded to the virtual storage is divided into a plurality of file blocks, and the file blocks are respectively transmitted to different cloud storage space and stored in different cloud storage spaces by the electronic device.

3. The cloud storage system of claim 2, wherein a portion or all of the file blocks are encrypted by the electronic device.

4. The cloud storage system of claim 2, wherein the electronic device determines a size of each of the file blocks according to an attribute of the file.

5. The cloud storage system of claim 4, wherein the electronic device determines that the file blocks are stored in the same cloud storage space or different cloud storage spaces according to the attribute of the file.

6. The cloud storage system of claim 5, wherein the electronic device backs up the file blocks by way of mirror backup or the electronic device restores lost file blocks by error-checking and/or correcting.

7. The cloud storage system of claim 6, wherein mirrored data generated by the mirror backup or error-checking and/or correcting data generated by the error-checking and/or correcting are uploaded along with the file blocks by the electronic device.

8. The cloud storage system of claim 6, wherein sufficient number of the cloud storage spaces are selected by the electronic device according to an connection speed between each of the cloud spaces and the electronic device to retrieve the file blocks so as to rebuild the file.

9. The cloud storage system of claim 7, wherein the mirrored data generated by the mirror backup or the error-checking and/or correcting data generated by the error-checking and/or correcting are stored in different cloud storage spaces by the electronic device.

10. A cloud storage management method, comprising the following steps of:
providing a plurality of cloud storage spaces for data access by at least one server;
providing a storage management interface by an electronic device, and connecting the electronic device to the at least one server via a network for accessing the cloud storage spaces; and
integrating the cloud storage spaces as a virtual storage space by the electronic device for a user to access data therefrom,
wherein the cloud storage spaces are concurrently accessed through the storage management interface, or accessed one at a time in multi-thread or multi-process manners, thereby improving an access speed thereof.

11. The cloud storage management method of claim 10, further comprising the following step of:
dividing a file attempted to be uploaded to the virtual storage space into a plurality of file blocks, and respectively transmitting the file blocks to different cloud storage spaces by the electronic device in order to store the file blocks in different cloud storage spaces.

12. The cloud storage management method of claim 11, further comprising the following step of:
encrypting a portion or all of the file blocks by the electronic device.

13. The cloud storage management method of claim 11, further comprising the following step of:
determining a size of each of the file blocks according to an attribute of the file by the electronic device.

14. The cloud storage management method of claim 13, further comprising the following step of:
determining that the file blocks are stored in the same cloud storage space or different cloud storage spaces according to the attribute of the file by the electronic device.

15. The cloud storage management method of claim 14, further comprising the following step of:
backing up the file blocks by way of mirror backup or calculating lost file blocks to restore the file by error-checking and/or correcting by the electronic device.

16. The cloud storage management method of claim 15, further comprising the following step of:
uploading mirrored data generated by the mirror backup or error-checking and/or correcting data generated by the error-checking and/or correcting along with the file blocks by the electronic device.

17. The cloud storage management method of claim 15, further comprising the following step of:
selecting sufficient number of the cloud storage spaces according to a connection speed between each of the cloud spaces and the electronic device by the electronic device to retrieve the file blocks so as to rebuild the file.

18. The cloud storage management method of claim 16, further comprising the following step of:
storing the mirrored data generated by the mirror backup or the error-checking and/or correcting data generated by the error-checking and/or correcting in different cloud storage spaces by the electronic device.

19. An electronic device, comprising a storage management interface, and the electronic device connected to a plurality of cloud storage spaces via a network;
wherein, the cloud storage spaces are integrated as a virtual storage space by the electronic device for a user to access data therefrom, the cloud storage spaces are concurrently accessed through the storage management interface, or accessed one at a time in multi-thread or multi-process manners, thereby improving an access speed thereof.

20. The electronic device of claim 19, wherein a file attempted to be uploaded to the virtual storage is divided into a plurality of file blocks, and the file blocks are respectively transmitted to different cloud storage space and stored in different cloud storage spaces.

21. The electronic device of claim 20, wherein a portion or all of the file blocks are encrypted by the electronic device.

22. The electronic device of claim 20, wherein the electronic device determines a size of each of the file blocks according to an attribute of the file.

23. The electronic device of claim 22, wherein the electronic device determines that the file blocks are stored in the same cloud storage space or different cloud storage spaces according to the attribute of the file.

24. The electronic device of claim 23, wherein the electronic device backs up the file blocks by way of mirror backup or the electronic device restores lost file blocks by error-checking and/or correcting.

25. The electronic device of claim 24, wherein mirrored data generated by the mirror backup or error-checking and/or correcting data generated by the error-checking and/or correcting are uploaded along with the file blocks by the electronic device.

26. The electronic device of claim 24, wherein sufficient number of the cloud storage spaces are selected by the electronic device according to an connection speed between each of the cloud spaces and the electronic device to retrieve the file blocks so as to rebuild the file.

27. The electronic device of claim 25, wherein the mirrored data generated by the mirror backup or the error-checking and/or correcting data generated by the error-checking and/or correcting are stored in different cloud storage spaces by the electronic device.

28. A tangibly embodied computer readable medium carrying a computer program adopted to cause a computer to perform a method comprises the following steps of:
providing a storage management interface by the computer, and connecting the computer to at least one server providing cloud storage spaces via a network for accessing the cloud storage spaces;
integrating the cloud storage spaces as a virtual storage space by the computer for a user to access data therefrom; and
concurrently accessing the cloud storage spaces through the storage management interface of the computer, or accessing one of the cloud storage spaces by multi-thread or multi-process so as to raise an access speed of the computer.

29. The tangibly embodied computer readable medium of claim 28, wherein the method further comprises the following step of:
dividing a file attempted to be uploaded to the virtual storage space into a plurality of file blocks, and respectively transmitting the file blocks to different cloud storage spaces by the computer in order to store the file blocks in different cloud storage spaces.

30. The tangibly embodied computer readable medium of claim 29, wherein the method further comprises the following step of:
encrypting a portion or all of the file blocks by the computer.

31. The tangibly embodied computer readable medium of claim 29, wherein the method further comprises the following step of:
determining a size of each of the file blocks according to an attribute of the file by the computer.

32. The tangibly embodied computer readable medium of claim 31, wherein the method further comprises the following step of:
determining that the file blocks are stored in the same cloud storage space or different cloud storage spaces according to the attribute of the file by the computer.

33. The tangibly embodied computer readable medium of claim 32, wherein the method further comprises the following step of:
backing up the file blocks by way of mirror backup or calculating lost file blocks to restore the file by error-checking and/or correcting by the computer.

34. The tangibly embodied computer readable medium of claim 33, wherein the method further comprises the following step of:
uploading mirrored data generated by the mirror backup or error-checking and/or correcting data generated by the error-checking and/or correcting along with the file blocks by the computer.

35. The tangibly embodied computer readable medium of claim 33, wherein the method further comprises the following step of:
selecting sufficient number of the cloud storage spaces according to a connection speed between each of the cloud spaces and the computer by the computer to retrieve the file blocks so as to rebuild the file.

36. The tangibly embodied computer readable medium of claim 34, wherein the method further comprises the following step of:
storing the mirrored data generated by the mirror backup or the error-checking and/or correcting data generated by the error-checking and/or correcting in different cloud storage spaces by the computer.

37. A cloud storage system, comprising:
a server, arranged for providing a cloud storage space for data access; and
an electronic device, comprising a storage management interface, the electronic device connected to the at least one server via a network for accessing the cloud storage space,
wherein the cloud storage space is accessed in multi-thread or multi-process manners through the storage management interface of the electronic device by a user, thereby improving an access speed thereof.
